(19) United States
(12) Patent Application Publication
(10) Pub. No.: US 2025/0036047 A1
(43) Pub. Date: Jan. 30, 2025

(54) TRANSFER DEVICE AND IMAGE FORMING APPARATUS

(71) Applicant: FUJIFILM Business Innovation Corp., Tokyo (JP)

(72) Inventors: Yoko MIYAMOTO, Kanagawa (JP); Toshiaki BABA, Kanagawa (JP); Tomohiro WADA, Kanagawa (JP)

(73) Assignee: FUJIFILM Business Innovation Corp., Tokyo (JP)

(21) Appl. No.: 18/596,566

(22) Filed: Mar. 5, 2024

(30) Foreign Application Priority Data
Jul. 27, 2023 (JP) 2023-122888

(51) Int. Cl. G03G 15/16

(52) U.S. Cl. CPC G03G 15/1675

(57) ABSTRACT

A transfer device includes: a transfer cylinder that is rotated, and that includes a cylinder main body having an outer circumferential surface provided with a recess for housing a holding member holding a leading end of a recording medium to convey the recording medium, and a sheet member that is wound around the outer circumferential surface, both ends of which are attached to circumferential ends of the recess, respectively, and that has an inclined surface on a downstream end in a conveying direction of the recording medium; and a transfer member to which a transfer voltage is applied and that transfers a developer image to the recording medium held and conveyed by the holding member, at a transfer position, wherein application of the transfer voltage to the transfer member is started after a tip end of the inclined surface arrives at the transfer position.

### CROSS-REFERENCE TO RELATED APPLICATIONS

This application is based on and claims priority under 35 USC 119 from Japanese Patent Application No. 2023-122888 filed Jul. 27, 2023.

### BACKGROUND

### (i) Technical Field

The present invention relates to a transfer device and an image forming apparatus.

### (ii) Related Art

JP1983-005769A (JPS58-005769A) discloses a technology related to a transfer device for transferring an image on an image carrier. According to this related art, the transfer device includes: a transfer medium conveyor for endlessly moving a transfer medium along a circulating movement path; a gripper piece attached to the conveyor, pivotally supported on a rotary shaft, and rotating with respect to a base member, to grip the leading end of the transfer medium; and a switch member attached to the base member. By providing a cutout to a part of the gripper piece at a position corresponding to the position of the switching member, the presence of the transfer medium in the gripper is detected.

JP2022-63753A discloses a technology related to a transfer device and an image forming apparatus. In this related art, the transfer device includes: a secondary transfer roller to which a voltage is applied from a power feeder to form a transfer electric field for transferring a developer image onto a sheet member; a transfer cylinder provided with a recess in which a grip member for gripping the leading end of the sheet member is housed, and forming a transfer electric field with the secondary transfer roller at the secondary transfer position; a short circuit for short-circuiting the voltage applied to the secondary transfer roller to a reference potential point; and a grounding unit that causes the short circuit to operate at the timing at which the recess enters the secondary transfer position, and causes the short circuit to stop operating when the recess goes out of the secondary transfer position, as the transfer cylinder is rotated.

### SUMMARY

The transfer cylinder includes a sheet member that is wound around the cylinder main body and one end of which has an inclined surface. A recess is provided to the transfer cylinder. A holding member is housed inside the recess on the transfer cylinder, and holds the leading end of a recording medium to convey the recording medium. The transfer member applied with the reference voltage as a transfer voltage then transfers a developer image onto the recording medium being thus conveyed. At this time, the transfer voltage sometimes causes the recording medium to electrostatically stick to the inclined surface, and causes the trailing end of the recording medium to float at a position behind the inclined surface, and to cause a transfer defect such as smear.

Aspects of non-limiting embodiments of the present disclosure relate to a transfer device that reduces transfer defects, as compared with a configuration in which the application of the transfer voltage to the transfer member is started, with the sheet member being moved as the transfer cylinder is rotated, before the tip end of the inclined surface of the sheet member arrives at the transfer position.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a transfer device comprising:
a transfer cylinder that is rotated, and that includes a cylinder main body having an outer circumferential surface provided with a recess for housing a holding member holding a leading end of a recording medium to convey the recording medium, and a sheet member that is wound around the outer circumferential surface, both ends of which are attached to circumferential ends of the recess, respectively, and that has an inclined surface on a downstream end in a conveying direction of the recording medium; and
a transfer member to which a transfer voltage is applied and that transfers a developer image to the recording medium held and conveyed by the holding member, at a transfer position,
wherein application of the transfer voltage to the transfer member is started after a tip end of the inclined surface arrives at the transfer position.

### BRIEF DESCRIPTION OF THE DRAWINGS

Exemplary embodiments of the present invention will be described in detail based on the following figures, wherein:

FIG. 1 is a configuration diagram schematically illustrating an entire image forming apparatus according to an exemplary embodiment of the present invention;

FIG. 2 is a perspective view illustrating a chain gripper of a transfer device included in the image forming apparatus in FIG. 1;

FIG. 3 is a perspective view illustrating a fixing device included in the image forming apparatus in FIG. 1;

FIG. 4 is a perspective view of a transfer cylinder, a secondary transfer roller, and a counter roller included in the transfer device included in the image forming apparatus in FIG. 1;

FIG. 5 is a wiring diagram of an application circuit of the transfer device included in the image forming apparatus in FIG. 1;

FIGS. 6A, 6B, and 6C are operation diagrams illustrating a sheet member conveying operation performed by the transfer device;

FIG. 7 is an end face view of the transfer cylinder included in the transfer device, as viewed from an axial direction;

FIG. 8 is an explanatory diagram for explaining a secondary transfer position;

FIG. 9A is a schematic diagram schematically illustrating the secondary transfer roller going into and coming out of a recess on the transfer cylinder included in the transfer device;

FIG. 9B is an enlarged view of the portion B in FIG. 9A;

FIG. 10 is a timing chart of the timing at which the transfer voltage of the transfer device is switched;

FIG. 11 is a table summarizing the results of experiments experimenting the relationship of timing T2, timing T3, and transfer defect;

FIG. 12 is an explanatory diagram for explaining the time required for the reference voltage to be reached, from when the application of the transfer voltage is started;

FIG. 13 is a timing chart for switching from an intermediate voltage to the transfer voltage;

FIG. 14 is a timing chart of an example in which the voltage is switched to the transfer voltage prior to the tip end of the inclined surface;

FIG. 15 is a timing chart in which the voltage is switched to the transfer voltage according to a comparative example; and

FIG. 16 is a block diagram of a hardware configuration of a control device.

### DETAILED DESCRIPTION

### Exemplary Embodiment

An example of a transfer device and an image forming apparatus according to an exemplary embodiment of the present invention will be now described. In the figures, the arrow H indicates the height direction (vertical direction) of the apparatus; the arrow W indicates the width direction (horizontal direction) of the apparatus, and the arrow D indicates the depth direction (horizontal direction) of the apparatus.

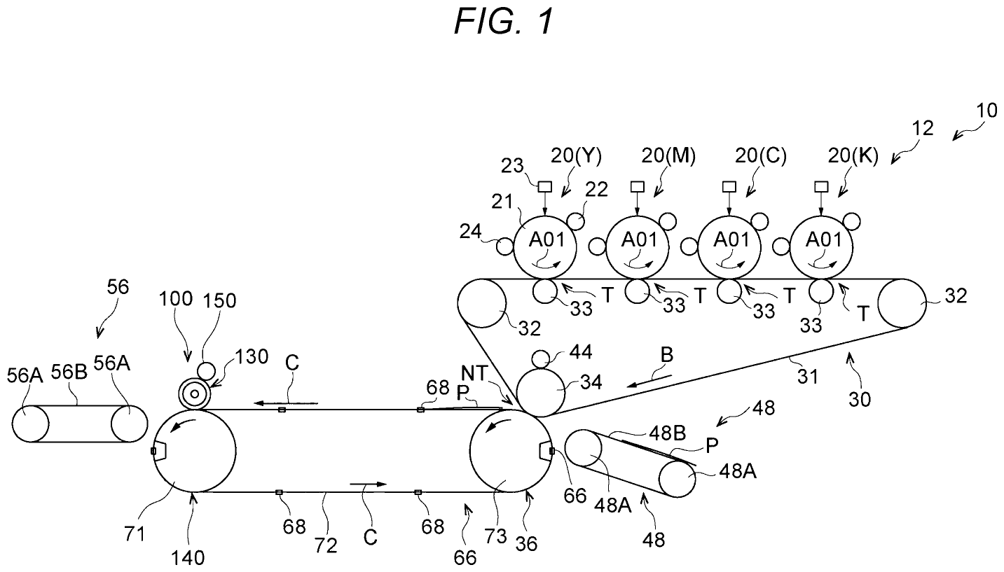

All of the figures used in the following description are schematic representations, and dimensions, ratios, and the like of the respective elements do not necessarily correspond to actual ones. The dimensions, ratios, and the like of the elements in the figures are not necessarily consistent with one another. In particular, FIG. 1 is a configuration diagram schematically illustrating the entire image forming apparatus, and therefore, specific details thereof do not exactly coincide with those in the other figures illustrating the detail. Substantially the same components will be given the same reference numerals, and the description thereof will be sometimes omitted.

### [Image Forming Apparatus]

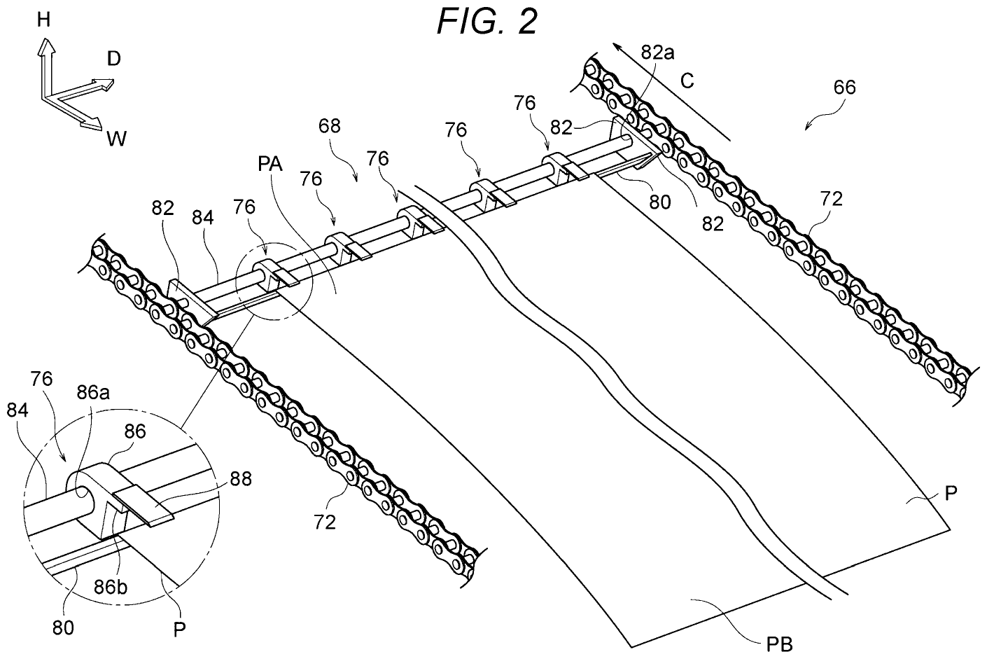

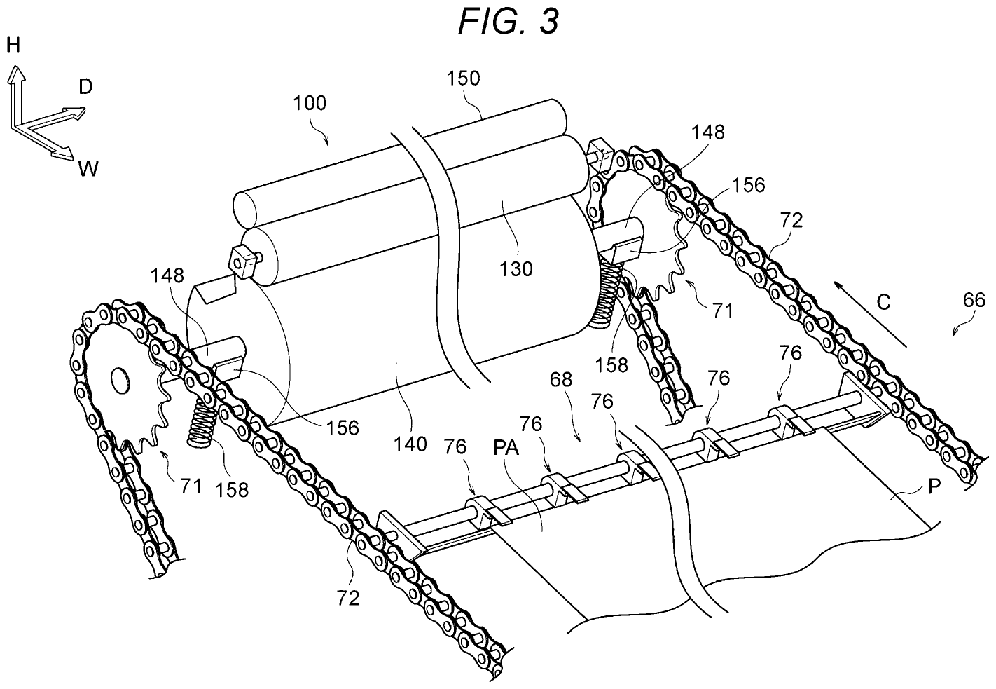

An image forming apparatus 10 according to the exemplary embodiment illustrated in FIG. 1 is an electrophotographic image forming apparatus that forms a toner image on sheet-like recording paper P (see FIGS. 2 and 3) as a recording medium. The image forming apparatus 10 includes a paper feeder mechanism 48, an image forming unit 12, a fixing device 100, and a paper ejector mechanism 56. Each of these mechanisms will now be described one by one.

### (Paper Feeder Mechanism)

The paper feeder mechanism 48 has a function of conveying the recording paper P stored in a storage, not illustrated, to a chain gripper 66, which is to be described later. The paper feeder mechanism 48 includes a ring-shaped conveyor belt 48B wound around a pair of rollers 48A. The recording paper P is then conveyed by the conveyor belt 48B, and the recording paper P is delivered to grip members 76 (see FIG. 2), which will be described later.

### (Image Forming Unit)

The image forming unit 12 has a function of forming an image on the recording paper P using electrophotography. The image forming unit 12 includes a toner image forming unit 20 that forms a toner image, and a transfer device 30 that transfers the toner image formed by the toner image forming unit 20 onto the recording paper P. Note that the toner image is an example of a developer image, and the toner image forming unit is an example of a developer image forming unit.

### (Toner Image Forming Unit)

The toner image forming unit 20 is provided in plurality so as to form toner images in different colors. The image forming unit 12 according to the present exemplary embodiment includes toner image forming units 20 corresponding to four colors in total, that is, yellow (Y), magenta (M), cyan (C), and black (K). Note that (Y), (M), (C), and (K) appended to reference numerals indicate that such elements correspond to the respective colors. When yellow (Y), magenta (M), cyan (C), and black (K) are not distinguished from one another, (Y), (M), (C), and (K) following the reference numerals are omitted in the description.

The toner image forming units 20Y 20M, 22C, and 22K for the respective colors are basically configured in the same manner, except for the toners used. Therefore, the toner image forming units will be described without distinguishing their colors. These toner image forming units 20Y, 20M, 20C, and 20K are arranged along an upper horizontal part of a transfer belt 31 included in the transfer device 30.

The toner image forming unit 20 includes a photosensitive drum 21 that rotates in a direction indicated by the arrow A01 in the figure, and a charger 22 that charges the photosensitive drum 21. The toner image forming unit 20 also includes an exposure device 23 that forms an electrostatic latent image by exposing the photosensitive drum 21 charged by the charger 22, and a developing device 24 that forms a toner image by developing the electrostatic latent image.

### (Transfer Device)

The transfer device 30 has the functions of primarily transferring the toner images on the photosensitive drums 21 of the toner image forming units 20 corresponding to the respective colors, onto the intermediate transfer body, in a manner overlapping one another, and of secondarily transferring the overlapping toner images onto the recording paper P. The transfer device 30 includes the transfer belt 31 as an example of an intermediate transfer body, a plurality of rollers 32, primary transfer rollers 33, a secondary transfer roller 34, and a transfer cylinder 36. The transfer device 30 also includes an application roller 44 that applies a voltage to the secondary transfer roller 34, and a chain gripper 66 that conveys the recording paper P.

The transfer belt 31 has an endless shape, and is wound around the plurality of rollers 32 and the secondary transfer roller 34 in a manner delineating an inverted triangular shape. The transfer belt 31 is circulated in a direction of the arrow B, by at least one of the plurality of rolls 32 that are driven in rotation.

The primary transfer rollers 33 are disposed facing the respective photosensitive drums 21 for the respective colors, with the transfer belt 31 nipped therebetween. The primary transfer roller 33 has a function of transferring the toner image on the photosensitive drum 21 onto the transfer belt 31 at a primary transfer position T formed between the photosensitive drum 21 and the primary transfer roller 33.

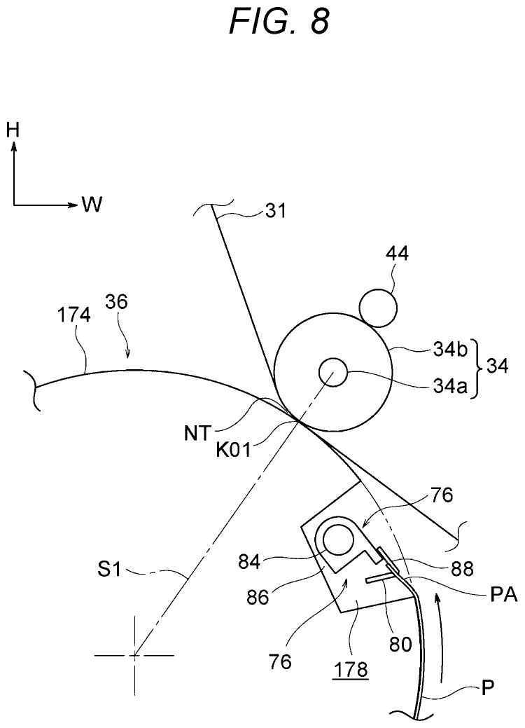

The transfer cylinder 36 has a circular cross section, and is disposed facing the secondary transfer roller 34, with the transfer belt 31 nipped therebetween. The transfer cylinder 36 has a function of transferring the toner image having been transferred onto the transfer belt 31, onto the recording paper P at a secondary transfer position NT (see FIG. 8) formed between the transfer belt 31 and the transfer cylinder 36.

The chain gripper 66 includes a pair of chains 72, sprockets 71, 73, and a gripping unit 68 (see FIG. 2) including grip members 76 for gripping the leading end of the recording paper P. The grip members 76 is an example of a holding member.

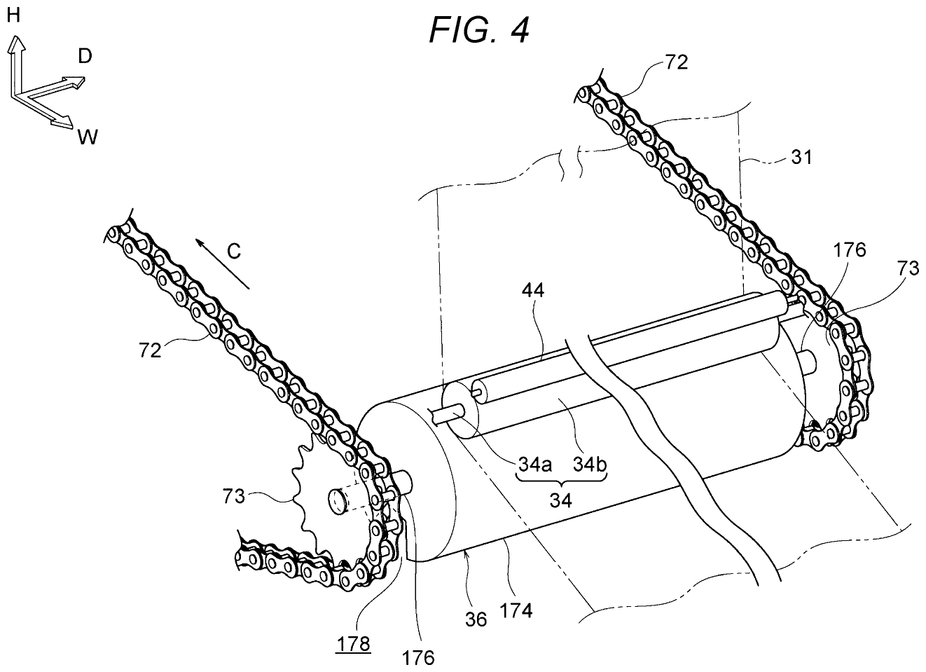

As illustrated in FIG. 2, the pair of chains 72 are disposed apart from each other in the depth direction of the apparatus, and the chains 72 are formed endlessly. As illustrated in FIG. 4, the pair of chains 72 are wound around a pair of sprockets 73 that are disposed on one end and the other end of the transfer cylinder 36, respectively, in the axial direction, and that have their axial directions extending in the depth direction of the apparatus. As illustrated in FIG. 3, the pair of chains 72 are disposed on one end and the other end of a pressing roller 140, to be described later, in the axial direction, and are wound around the pair of sprockets 71 having the axial direction extending in the depth direction of the apparatus.

As illustrated in FIG. 1, each of the chains 72 is wound around the sprocket 71 disposed on the corresponding one of the ends of the pressing roller 140, and the sprocket 73 disposed on the corresponding one of the ends of the transfer cylinder 36. When the rotational force is transmitted to one of the plurality of sprockets 71, 73, the pair of chains 72 rotate in the direction of the arrow C in the figure, and moves from the side of the sprockets 73 toward the side of the sprockets 71. Note that in the present exemplary embodiment, the rotational force is transmitted to the sprockets 73.

The gripping unit 68 is provided in plurality, and arranged at predetermined intervals along the circumferential direction (circulating direction) of the chains 72. As illustrated in FIG. 2, each of the gripping unit 68 extends in the depth direction of the apparatus, and portions of the gripping unit 68 on both sides in the depth direction of the apparatus are attached to the pair of chains 72, respectively. The gripping unit 68 also includes metal grip members 76 for gripping the leading end of the recording paper P.

The chain gripper 66 conveys the recording paper P along the circulating direction of the pair of chains 72. Elements of the transfer device 30, including the secondary transfer roller 34, the application roller 44, the chain gripper 66, and the transfer cylinder 36 will be described later.

### (Fixing Device)

The fixing device 100 illustrated in FIG. 1 has a function of fixing the toner image having been transferred in the transfer device 30 onto the recording paper P, onto the recording paper P.

As illustrated in FIG. 3, the fixing device 100 includes a heating roller 130 that comes into contact with the recording paper P being conveyed, to heat the recording paper P, a pressing roller 140 that presses the recording paper P against the heating roller 130, and a driven roller 150 that rotates by being driven by the heating roller 130 and heats the heating roller 130.

The fixing device 100 also includes support members 156 coming into contact with a shaft 148 of the pressing roller 140 and supporting the pressing roller 140, and biasing members 158 each applying biasing force to the pressing roller 140 toward the heating roller 130, with the corresponding one of the support members 156 interposed therebetween.

The driven roller 150 rotates by being driven by the rotation of the heating roller 130. The heating roller 130 and the pressing roller 140 nip and convey the recording paper P having the toner image transferred, thereby heating and fixing the toner image onto the recording paper P.

### (Paper Ejector Mechanism)

The paper ejector mechanism 56 illustrated in FIG. 1 has a function of ejecting the recording paper P having the toner image fixed by the fixing device 100, to an ejector unit, not illustrated. The paper ejector mechanism 56 also has a function of receiving the recording paper P released from the grip members 76 (see FIG. 2), and conveying the recording paper P. The paper ejector mechanism 56 includes a ring-shaped conveyor belt 56B wound around a pair of rollers 56A. The recording paper P is then conveyed by the conveyor belt 56B, and the recording paper P is ejected to the ejector unit, not illustrated.

### (Control Device)

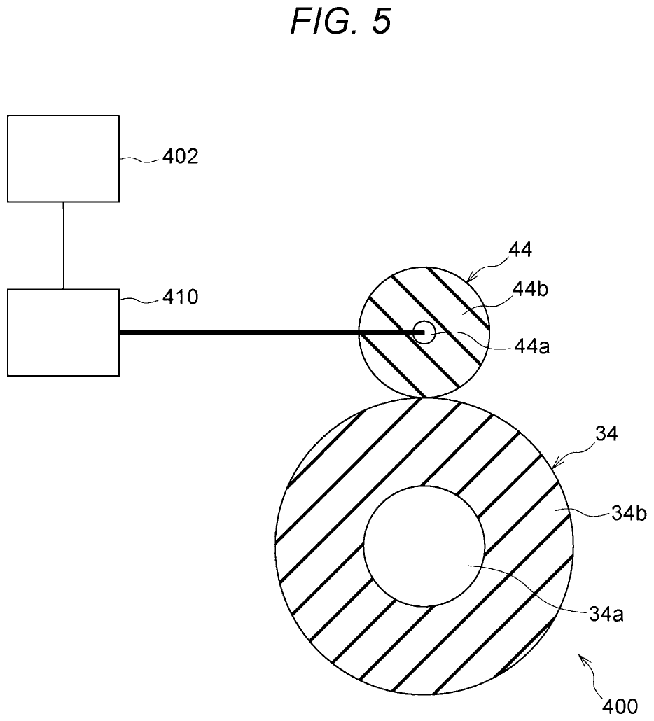

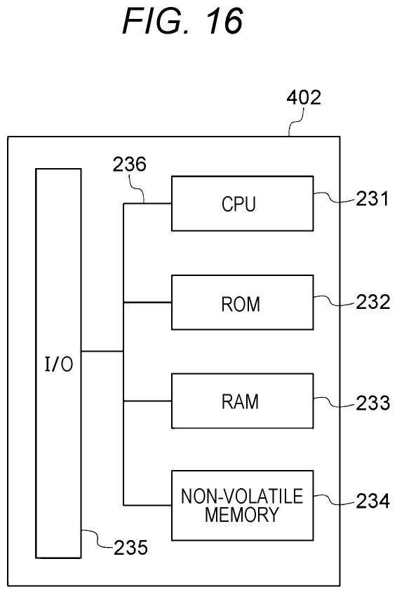

The control device 402 illustrated in FIG. 5 has a function of controlling the entire image forming apparatus 10 (see FIG. 1). As illustrated in FIG. 16, an example of a hardware configuration of the control device 402 includes a central processing unit 231 that executes various processes, a read-only memory (ROM) 232 that stores therein various programs, a random access memory (RAM) 233 that is used as a temporary working area of the CPU 231, a nonvolatile memory 234, and an I/O 235 that is an input/output interface. The CPU 231, the ROM 232, the RAM 233, the nonvolatile memory 234, and the I/O 235 are connected to one another via a bus 236.

### [Outline of Image Forming Operation]

The image forming apparatus 10 illustrated in FIG. 1 forms a toner image on the recording paper P in the following manner.

To begin with, the charger 22 corresponding to each of the colors charges the surface of the photosensitive drum 21 for the corresponding color uniformly negatively, at a predetermined potential. The exposure device 23 then irradiates the charged surface of the photosensitive drum 21 of the corresponding color with exposure light, based on image data input from the outside, and forms an electrostatic latent image.

As a result, an electrostatic latent image corresponding to the image data is formed on the surface of the corresponding photosensitive drum 21. The developing device 24 of the corresponding color then develops the electrostatic latent image, and visualizes the electrostatic latent image as a toner image. The primary transfer roller 33 of the transfer device 30 then transfers the toner images formed on the surface of the photosensitive drum 21 corresponding to each of the colors onto the transfer belt 31 at the primary transfer position T.

A recording paper P sent out from a storage, not illustrated, is conveyed by the paper feeder mechanism 48, delivered to the chain gripper 66, and conveyed by the chain gripper 66. The recording paper P conveyed by the chain gripper 66 is sent to the secondary transfer position NT (see FIG. 8) where the transfer belt 31 and the transfer cylinder 36 is contact with each other. At the secondary transfer position NT, the recording paper P is conveyed by being nipped between the transfer belt 31 and the transfer cylinder 36, and thus the toner images on the surface of the transfer belt 31 are transferred onto the surface of the recording paper P.

The fixing device 100 fixes the toner image having been transferred onto the surface of the recording paper P on the recording paper P, and the recording paper P is sent out to the paper ejector mechanism 56. The recording paper P sent to the paper ejector mechanism 56 is ejected to the ejector unit 52, not illustrated.

### [Main Structures of Transfer Device]

Next, main structures of the transfer device 30 will be described. Specifically, structures such as the chain gripper 66, the secondary transfer roller 34, the application roller 44, the transfer cylinder 36, and the application circuit 400, included in the transfer device 30 will be described.

### (Chain Gripper)

As described above, the chain gripper 66 illustrated in FIG. 3 includes the pair of chains 72, the sprockets 71, 73, and the gripping unit 68 (see FIG. 2) including the grip members 76 for gripping the leading end of the recording paper P. The chain gripper 66 is an example of a conveying member.

As illustrated in FIG. 2, the gripping unit 68 includes a plate portion 80 extending in the depth direction of the apparatus, a pair of support plates 82 supporting the plate portion 80, and a shaft member 84 extending in the depth direction of the apparatus and having ends attached to the respective chains 72. The gripping unit 68 also includes the grip members 76 for gripping the leading end of the recording paper P between the grip members 76 and the plate portion 80.

As illustrated in FIG. 2, the plate portion 80 is made of stainless steel and is positioned between the pair of chains 72. The plate portion 80 is inclined with respect to the sheet conveying direction so that an upstream portion of the plate portion 80 in the sheet conveying direction is closer to the recording paper P, than the downstream portion, in a view in the depth direction of the apparatus.

The support plates 82 are made of stainless steel, and are disposed at respective ends of the plate portion 80, with the plate thickness direction thereof disposed along the depth direction of the apparatus. The ends of the plate portion 80 are attached to the pair of support plates 82, respectively, and the pair of support plates 82 support the plate portion 80. Each of the support plates 82 has a circular through hole 82a.

The shaft member 84 is made of stainless steel, extends in the depth direction of the apparatus, and is disposed on the downstream side of the plate portion 80 in the sheet conveying direction. The shaft member 84 is also passed through the through holes 82a of the respective support plates 82. Ends of the shaft member 84 are attached to the pair of chains 72, respectively.

### (Grip Members)

As illustrated in FIG. 2, a plurality of grip members 76, as an example of a holding member, are provided, and are attached to the shaft member 84 at predetermined intervals along the depth direction of the apparatus. Each of the grip members 76 includes a main body 86 having a through hole 86a through which the shaft member 84 is passed, and a contact portion 88 coming into contact with the recording paper P.

The main body 86 is made of aluminum, and a downstream portion of the main body 86 in the sheet conveying direction has an arc shape, in a view from the depth direction of the apparatus. The main body 86 has a protrusion 86b that protrudes toward the plate portion 80, on a part on the upstream side in the sheet conveying direction, and on the outer side with respect to the endless chain 72 (=the side opposite to the area surrounded by the endless chain 72, in a view in the depth direction of the apparatus). The protrusion 86b has a rectangular shape in a view from the protruding direction.

The contact portion 88 is a plate member made of stainless steel, and is attached to a surface of the protrusion 86b, the surface facing the outer side of the endless chain 72. The contact portion 88 extends from the protrusion 86b toward the plate portion 80, and is contact with the outer side of the plate portion 80, being outer with respect to the endless chain 72.

The shaft member 84 is rotated by a cam mechanism, not illustrated, and presses the contact portion 88 toward the plate portion 80 from the outer side of the endless chain 72, bring the contact portion 88 into contact with the plate portion 80, and separates the contact portion 88 from the plate portion 80. In this manner, the leading end of the recording paper P is gripped with or released from the grip members 76.

### (Secondary Transfer Roller)

As illustrated in FIG. 4, the secondary transfer roller 34 extends in the depth direction of the apparatus, and the transfer belt 31 is wound around the secondary transfer roller 34. The secondary transfer roller 34 includes a shaft member 34a and a cylindrical roller portion 34b through which the shaft member 34a is passed. The secondary transfer roller 34 is an example of a transfer member. The depth direction of the apparatus is an example of an axial direction.

The shaft member 34a is a shaft made of stainless steel, and both ends of the shaft member 34a are supported by a frame, not illustrated, via bearings, respectively. The roller portion 34b is made of rubber, and is attached to the shaft member 34a so as to rotate together with the shaft member 34a. Note that the shaft member 34a may be made of any conductive body, and preferably made of a metal, and more preferably, stainless steel. The secondary transfer roller 34 is driven in rotation by the circulating transfer belt 31.

### (Application Roller)

As illustrated in FIG. 4, the application roller 44 as an example of an application member has a smaller diameter than the secondary transfer roller 34, and is disposed on the opposite side of the transfer belt 31 with the secondary transfer roller 34 interposed therebetween. The application roller 44 extends in the depth direction of the apparatus, and is in contact with the outer circumferential surface of the secondary transfer roller 34.

The application roller 44 is driven in rotation by the rotating secondary transfer roller 34. The application roller 44 also applies a voltage to the secondary transfer roller 34 by receiving a power supply from a power feeder 410 (see FIG. 5) to the shaft of the application roller 44. With this, a transfer electric field for transferring the toner images on the transfer belt 31 onto the recording paper P is formed at the secondary transfer position NT (see FIG. 8) between the secondary transfer roller 34 and the transfer cylinder 36.

### (Transfer Cylinder)

As illustrated in FIG. 4, the transfer cylinder 36 is disposed on the opposite side of the secondary transfer roller 34, with the transfer belt 31 interposed therebetween. The transfer cylinder 36 extends in the depth direction of the apparatus.

The transfer cylinder 36 includes a roller portion 174, and a pair of shafts 176 protruding from respective ends of the roller portion 174, in the depth direction of the apparatus. The sprockets 73 are attached to the pair of shafts 176, respectively.

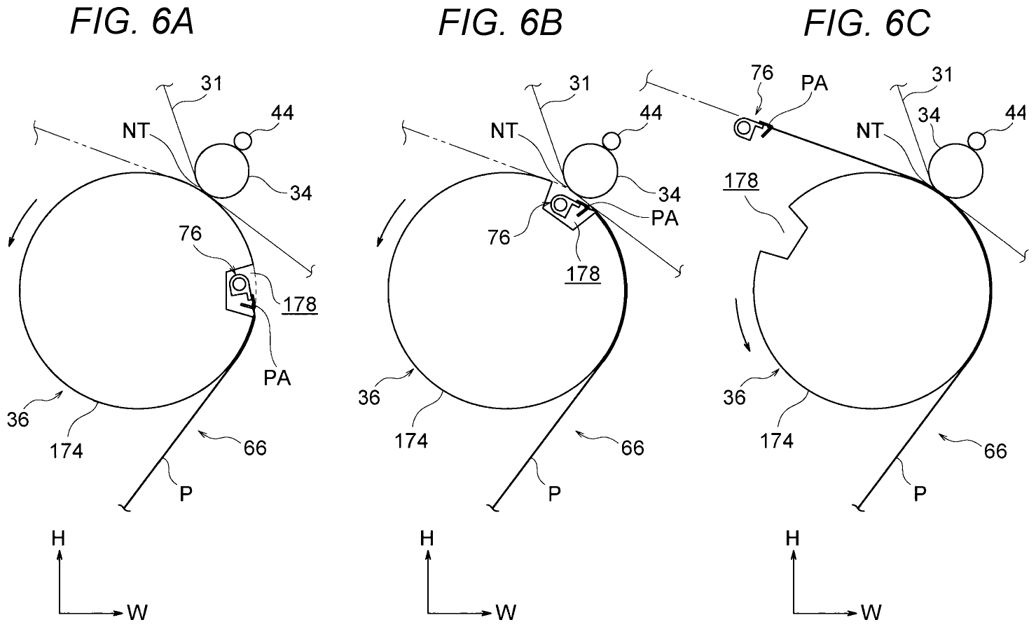

As illustrated in FIG. 6A, a recess 178 in which the grip members 76 are disposed is provided on the roller portion 174 of the transfer cylinder 36. The recess 178 extends in the depth direction of the apparatus from one end to the other end of the roller portion 174.

As illustrated in FIG. 6A, when the grip members 76 gripping the leading end of the recording paper P reaches the rotating transfer cylinder 36, the grip members 76 comes to be disposed inside the recess 178 of the roller portion 174. As illustrated in FIG. 6B, the recording paper P, the leading end of which is gripped and conveyed by the grip members 76, is conveyed as being wound around the rotating transfer cylinder 36, and becomes nipped between the roller portion 174 and the transfer belt 31, at the secondary transfer position NT (see FIG. 8). In this manner, the recording paper P, being conveyed, is conveyed as being wound around the transfer cylinder 36. In other words, the transfer cylinder 36 functions as a support unit for supporting the recording paper P.

The toner image on the transfer belt 31 is then transferred, with the transfer electric field at the secondary transfer position NT, onto the recording paper P.

As illustrated in FIG. 6C, the grip members 76 disposed in the recess 178 of the roller portion 174 comes out of the recess 178 of the rotating transfer cylinder 36, and the chain gripper 66 conveys the recording paper P to the downstream in the sheet conveying direction.

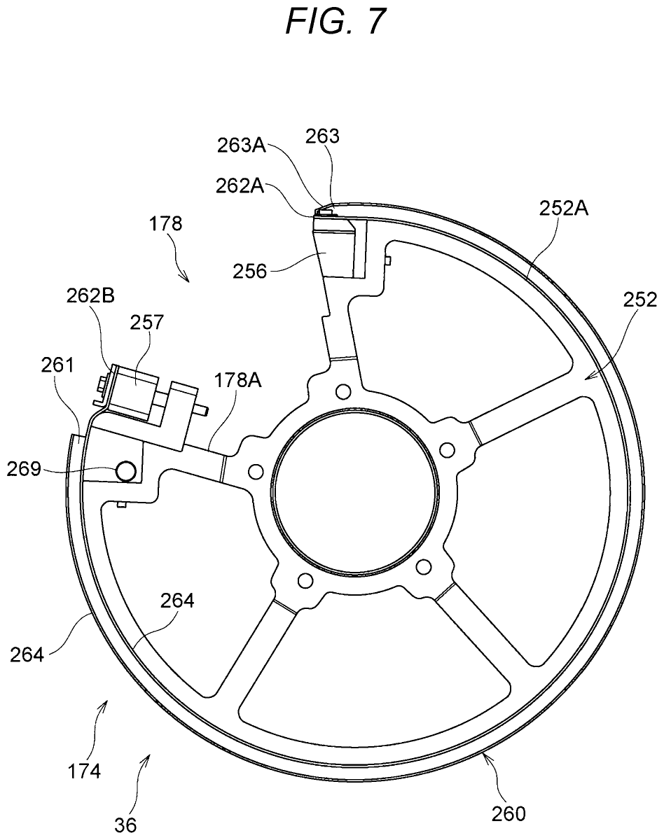

As illustrated in FIG. 7, the roller portion 174 of the transfer cylinder 36 includes a cylinder main body 252 made of metal such as aluminum, and a jacket member 260 as an example of a sheet member wound around an outer circumferential surface 252A of the cylinder main body 252 and providing an outer circumferential portion. The cylinder main body 252 has the recess 178 described above, along the axial direction on a part of the outer circumferential surface 252A.

The jacket member 260 is made of resin, and has a volume resistance higher than that of the cylinder main body 252 made of metal. The jacket member 260 includes a base layer 262 wound around the cylinder main body 252 non-adhesively, and a surface layer 264 wound around the outer circumferential surface of the base layer 262 in a manner adhered thereto. Attachment blocks 256 and 257 are provided at both ends of the recess 178 in the circumferential direction. The respective ends 262A, 260B of the base layer 262 of the jacket member 260 are fastened with bolts to the attachment blocks 256, 257, respectively, so that the jacket member 260 is detachably attached to the cylinder main body 252. In other words, the jacket member 260 is replaceable.

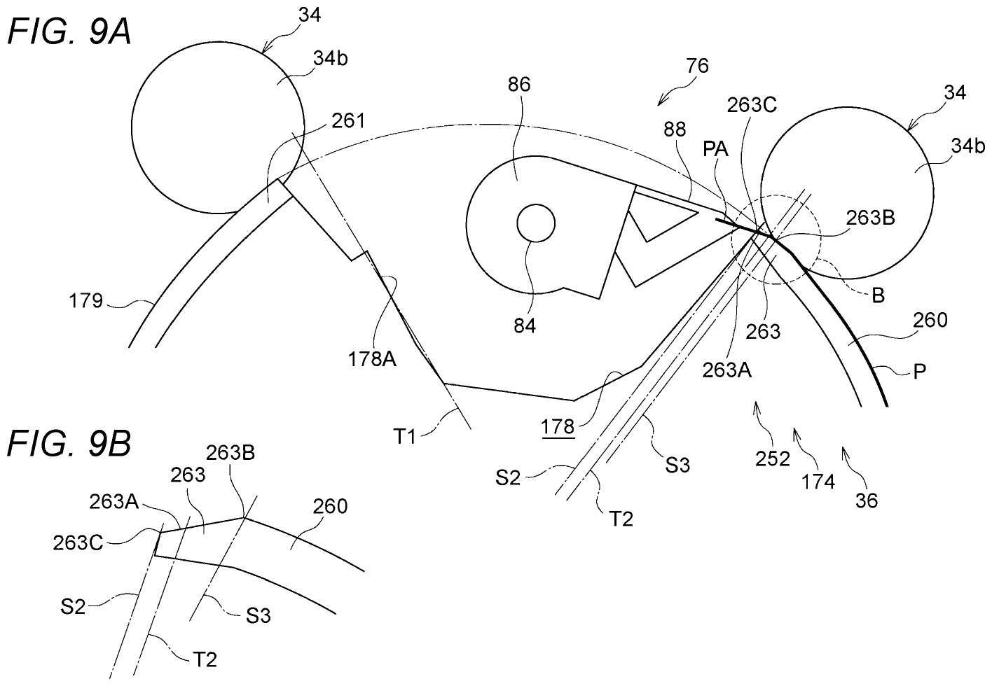

That is, as illustrated in FIGS. 7 and 9A, one end 261 of the jacket member 260 is attached to the attachment block 257 provided on one end of the recess 178, and the other end 263 is attached to the attachment block 256 provided on the other end of the recess 178.

As illustrated in FIGS. 9A and 9B, the other end 263 of the jacket member 260 has an inclined surface 263A that becomes thinner toward the tip. Describing from another viewpoint, the other end 263 of the jacket member 260, which is positioned on the upstream side of the recess 178 in the conveying direction of the recording paper P when the jacket member is at the secondary transfer position NT, has an inclined surface 263A that becomes thicker in the radial direction, as the inclined surface 263A extends toward upstream in the conveying direction. The rear end of the inclined surface 263A will be referred to as an inclination rear end 263B, and the tip is an inclination tip end 263C.

As illustrated in FIG. 9A, a part of a circumferential surface of the roller portion 174 of the transfer cylinder 36 other than the recess 178 will be referred to as a cylinder circumferential portion 179. The two secondary transfer rollers 34 are illustrated in FIG. 9A, and the reason therefore will be described later.

### (Application Circuit)

As illustrated in FIG. 5, the application circuit 400 includes the power feeder 410, the application roller 44, and the secondary transfer roller 34. The application roller 44 includes a shaft member 44a and a cylindrical roller portion 44b through which the shaft member 44a is passed. As described earlier, power is supplied from the power feeder 410 to the shaft member 44a of the application roller 44, so that a voltage is applied to the secondary transfer roller 34, and a transfer electric field is formed at the secondary transfer position NT (see FIG. 1, for example).

### (Power Feeder)

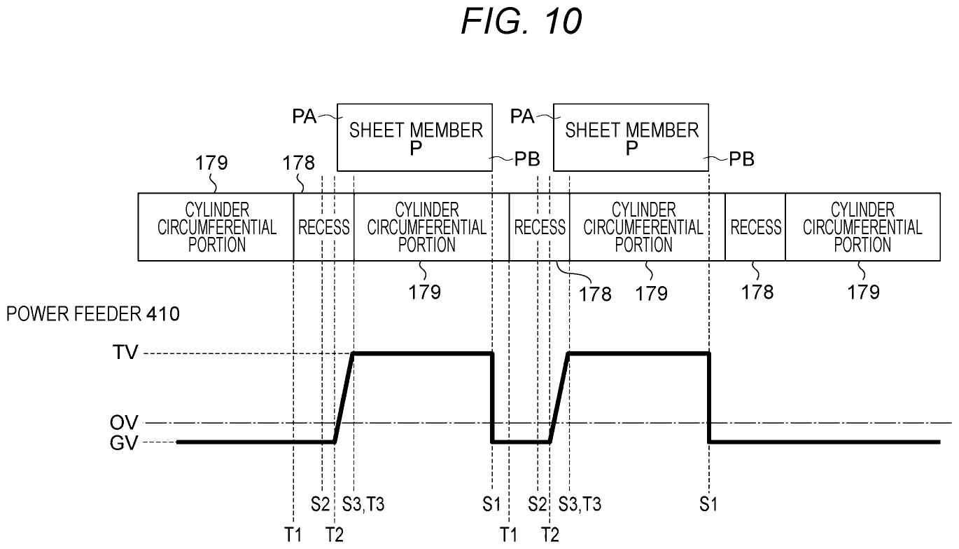

As illustrated in FIG. 10, the power feeder 410 can switch the voltage applied to the application roller 44 (see FIG. 5, for example) between a transfer voltage TV and a reverse voltage GV. FIG. 10 is a timing chart of the timing for switching the voltage, which will be described later.

The transfer voltage TV is a voltage for forming the transfer electric field at the secondary transfer position NT (see FIG. 1, for example). The reverse voltage GV has a polarity opposite to that of the transfer voltage TV, and has a small absolute value. The transfer voltage TV and the reverse voltage GV of the power feeder 410 is switched by an electric signal from the control device 402 (see FIG. 5).

In the present exemplary embodiment, the transfer voltage TV is switched to the reverse voltage GV based on a reference signal KS that is used for various kinds of timing adjustment in the entire image forming apparatus 10. In other words, the voltage is switched after the time designated to the reference signal has elapsed.

Note that in the present exemplary embodiment, the transfer voltage TV is switched to the reverse voltage GV based on a transfer signal TS, which is to be described later. In other words, the voltage is switched after the time designated to the transfer signal TS has elapsed.

### (Transfer Signal)

The transfer signal TS, which is as an example of a detection signal, is transmitted at timing T1 at which a detection mark provided on the transfer cylinder 36 arrives at a predetermined detection position, as the transfer cylinder 36 illustrated in FIG. 9A is rotated. As a detection method of detecting the arrival of the detection mark on the transfer cylinder 36 at the detection position, any method may be used.

For example, a detection mark, such as a projection made of resin or metal, is provided on an axial end surface of the roller portion 174 of the transfer cylinder 36, near a wall surface 178A of the recess 178. A photosensor, for example, electrically connected to the control device 402 (see FIG. 5) then detects the detection mark, when the detection mark passes a predetermined detection position, e.g., near the secondary transfer position NT, and transmits the transfer signal TS. Note that the detection mark 269 may also be provided on another member rotating integrally with the transfer cylinder 36, e.g., the shaft 176 of the transfer cylinder 36 or the sprocket 73.

### [Timing for Switching Voltage Supplied to Application Roller]

In FIG. 9A, the secondary transfer roller 34 is illustrated on the left side and right side of the figure. The secondary transfer roller 34 on the left is about to go into the recess 178 as the transfer cylinder 36 is rotated; and the secondary transfer roller 34 on the right is about to leave the recess 178 as the transfer cylinder 36 is rotated. Therefore, actually there is one secondary transfer roller 34.

As illustrated in FIG. 8, in a view in the depth direction of the apparatus, a point where a line (a line S1, a line S2, and a line S3, which are to be described later) connecting the rotation center of the secondary transfer roller 34 and the rotation center of the transfer cylinder 36 intersects with the outer circumferential surface of the secondary transfer roller 34 is referred to as an intersection K01. In the present exemplary embodiment, a line passing through the intersection K01 is defined as the secondary transfer position NT.

The line S1 illustrated in FIG. 8 is a position when the trailing end PB (FIG. 2) of the recording paper P being conveyed is arriving at the secondary transfer position NT. The line S1 indicates a position of a part provided with the jacket member 260 (see FIG. 9A, for example), before the recess 178 goes into the secondary transfer position NT, as the transfer cylinder 36 is rotated.

The line S2 illustrated in FIGS. 9A and 9B is a position where the inclination tip end 263C of the inclined surface 263A of the jacket member 260 arrives at the secondary transfer position NT, as the transfer cylinder 36 is rotated.

The line S3 illustrated in FIGS. 9A and 9B is a position where the inclination rear end 263B of the inclined surface 263A of the jacket member 260 arrives at the secondary transfer position NT, as the transfer cylinder 36 is rotated.

FIG. 10 is a timing chart for explaining the timing for switching the voltage supplied by the power feeder 410 (see FIG. 5). Timing T1 is timing at which the voltage is switched from the transfer voltage TV to the reverse voltage GV. Timing T2 is timing at which the voltage is switched from the reverse voltage GV to the transfer voltage TV. Timing T3 is timing at which the voltage reaches the transfer voltage TV.

Note that switching of the voltage to the transfer voltage TV and to the reverse voltage GV at the timing T1 and the timing T2, respectively, is triggered by an electrical signal output from the control device 402 (see FIG. 5) as described above. In other words, the voltage is switched by the CPU 231, which is an example of a processor of the control device 402.

As illustrated in FIG. 12, even if the power feeder 410 feeds power to the secondary transfer roller 34, it takes a time Δt for the voltage to reach the transfer voltage TV, which is the voltage to be applied to the secondary transfer roller 34. In the present exemplary embodiment, the voltage is considered to have completely risen when ±20% of the transfer voltage TV is reached. That is, the transfer voltage TV±20% corresponds to the reference voltage. Note that the reference voltage is a voltage required to transfer a toner image onto the recording paper P. To describe from another viewpoint, the reference voltage is a voltage at which a transfer defect does not occur.

### (Timing T1)

As illustrated in FIG. 10, the timing T1 is the timing at which the transfer voltage TV is switched to the reverse voltage GV, and is at the timing when the training end PB (FIG. 2) of the recording paper P being conveyed arrives at the secondary transfer position NT (line S1 in FIG. 9A).

### (Timing T2)

As illustrated in FIG. 10, the timing T2 is the timing at which the voltage to be fed by the power feeder 410 to the secondary transfer roller 34 is switched from the reverse voltage GV to the transfer voltage TV, and is later than the timing at which the inclination tip end 263C of the inclined surface 263A of the jacket member 260 arrives at the secondary transfer position NT (the line S2 in FIGS. 9A and 9B), as the transfer cylinder 36 is rotated.

### (Timing T3)

As illustrated in FIGS. 10 and 12, the timing T3 is a timing at which the voltage has complete risen to reach the transfer voltage TV, and arrives when the inclination rear end 263B of the inclined surface 263A of the jacket member 260 arrives at the secondary transfer position NT (the line S3 in FIGS. 9A and 9B). Note that, as described above, it is sufficient if ±20% of the transfer voltage TV is reached at the time of the line S3.

Although any method may be used as a method of making a preliminary adjustment so that the transfer voltage TV is reached at the line S3, in the present exemplary embodiment, the timing T2 is adjusted in advance so that the transfer voltage TV is reached at the position of the line S3. In other words, by adjusting the time length from the timing T1 to the timing T2 in advance, the voltage is set to reach the transfer voltage TV at the position of the line S3.

### [Operation]

Next, an operation according to the present exemplary embodiment will be described.

To begin with, a comparative example will be described. In the comparative example, as illustrated in FIG. 15, the transfer voltage TV is reached before the line S2 where the inclination tip end 263C of the inclined surface 263A of the jacket member 260 arrives at the secondary transfer position NT, as a result of the transfer cylinder 36 illustrated in FIGS. 9A and 9B being rotated.

In the comparative example, because the transfer voltage TV is reached before the line S2, as illustrated in FIG. 15, the inclined surface 263A becomes charged, and the leading end PA of the recording paper P electrostatically sticks to the inclined surface 263A.

Once the leading end PA of the recording paper P electrostatically sticks to the inclined surface 263A, a portion of the recording paper P positioned behind the inclination rear end 263B of the inclined surface 263A floats above the jacket member 260, due to the stiffness (rigidity) of the recording paper P, and may be brought into contact with the transfer belt 31, at a position upstream of the secondary transfer position NT in the conveying direction. Therefore, smear, that is, transfer defect, in which the developer image becomes offset at the portion of the recording paper P coming into contact with the transfer belt 31 on the upstream of the secondary transfer position NT in the conveying direction, occurs.

Therefore, in the present exemplary embodiment, by setting the timing T2 for switching the reverse voltage GV to the transfer voltage TV to be after the inclination tip end 263C of the inclined surface 263A has arrived at the secondary transfer position NT, the amount of charge in the inclined surface 263A is suppressed, so that the electrostatic force causing the leading end PA of the recording paper P to stick to the inclined surface 263A is reduced. Thus, the leading end PA of the recording paper P is less likely to electrostatically stick to the inclined surface 263A, and therefore, the portion of the recording paper P behind the inclination rear end 263B of the inclined surface 263A is suppressed from floating above the jacket member 260, due to the stiffness (rigidity) of the recording paper P. In other words, because the recording paper P is prevented or suppressed from coming into contact with the transfer belt 31, smear, that is, transfer defect is prevented or suppressed.

In this manner, transfer defect is better prevented or suppressed, compared with the comparative example in which the timing T2 for switching the reverse voltage GV to the transfer voltage TV arrives before the inclination tip end 263C of the inclined surface 263A arrives at the secondary transfer position NT. In other words, transfer defect is prevented or suppressed as compared with that in the configuration in which the transfer voltage TV is reached before the line S2 at which the inclination tip end 263C of the inclined surface 263A of the jacket member 260 arrives at the secondary transfer position NT.

At the secondary transfer position NT, after the transfer voltage TV rises to the reference voltage, the toner image is transferred to the recording paper P appropriately. Therefore, by setting the timing T2 for switching the reverse voltage GV to the transfer voltage TV to arrive after the secondary transfer position NT passes the line S3 corresponding to the inclination rear end 263B of the inclined surface 263A, transfer defect due to smearing is prevented or suppressed more reliably.

However, transfer defect also occurs behind the inclination rear end 263B, when the transfer voltage TV has not reached the reference voltage. It is also possible for the range where the image quality is assured to be smaller on the leading end of the recording paper P.

Note that, even before the transfer voltage TV reaches the reference voltage, the toner image is still transferred to the recording paper P but less densely. In particular, when the toner image is a high-density multicolor toner image, such a density reduction will be more prominent. Note that the term “high-density multicolor” refers to a toner image of two or more colors having a total CIN of 150% or higher.

Therefore, in the present exemplary embodiment, the timing T2 for switching the reverse voltage GV to the transfer voltage TV is set before the secondary transfer position NT passes through the line S3 corresponding to the inclination rear end 263B.

Furthermore, in this exemplary embodiment, the timing T3 at which the transfer voltage TV reaches the reference voltage is set at the time when the inclination rear end 263A of the inclined surface 263B arrives at the secondary transfer position NT. Therefore, it is possible to suppress transfer defect due to the transfer voltage TV not reaching the reference voltage behind the inclination rear end 263B. Alternatively, it is possible to ensure the image quality across a wider area on the leading end of the recording paper P.

Furthermore, in this exemplary embodiment, the timing T2 for switching the voltage from the reverse voltage GV to the transfer voltage TV is adjusted in advance, and the timing T3 for the transfer voltage TV to reach the reference voltage is set to the timing at which the secondary transfer position NT arrives at the inclination rear end 263A of the inclined surface 263B. Therefore, the control is simple compared with the configuration for adjusting the time Δt between the timing T2 and the timing T3 in advance.

Furthermore, in the present exemplary embodiment, the timing T2 is set based on the reference signal transmitted at the timing T1 at which the secondary transfer position NT arrives at the one end of the recess 178. In other words, the timing T2 is adjusted in advance, based on the time from the timing T1. Therefore, the precision of the timing T2 is improved compared with a detection signal resultant of detecting the recording paper P being conveyed upstream of the transfer cylinder 36 in the conveying direction, e.g., detecting the leading end PA of the recording paper P being conveyed on the conveyor belt 48B.

Furthermore, because the voltage is raised from the reverse voltage GV to the transfer voltage TV, the time Δt is longer than that when the voltage is raised from 0V to the transfer voltage TV. Therefore, it is possible to delay the timing T2 at which the transfer voltage TV reaches the reference voltage. Hence, it is possible to prevent smears by preventing the voltage from reaching the reference voltage ahead of the inclination rear end 263B of the inclined surface 263A.

### [Experimental Results]

Next, experimental results of experimenting the relationship of the timing T2, the timing T3, and the transfer defect will be described.

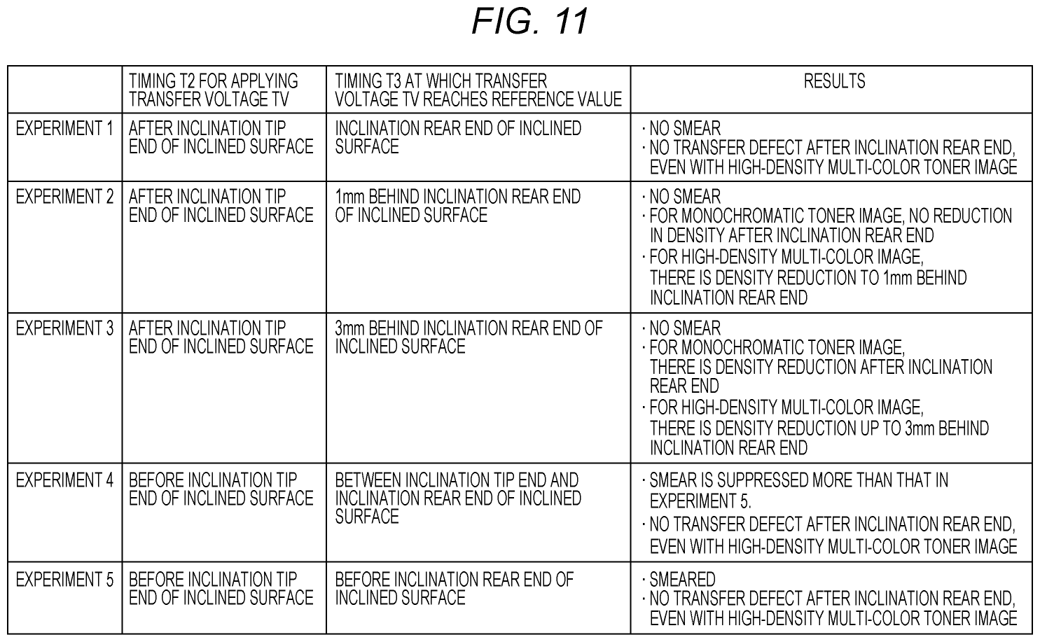

The table indicated in FIG. 11 is a table summarizing the results of experiments experimenting the relationship of the timing T2, the timing T3, and the transfer defect. Note that Experiment 1 is resultant of the conditions described in the present exemplary embodiment. Experiment 5 is resultant of the conditions described in the comparative example in FIG. 15.

As can be seen from the table in FIG. 11, neither smear nor reduction in density occurs in Experiment 1. In Experiment 2 and Experiment 3, no smear occurs, but a reduction in density is observed. In Experiment 4, the transfer defect does not occur, and the smear suppression effect is acknowledged. In Experiment 5, no transfer defect occurs, but smear occurs.

Note that the conditions of Experiment 2 and Experiment 3 can be used as long as the degree of reduction in the density is within an acceptable range. Even if the reduction in the density is not within the acceptable range, these conditions can be used by narrowing the range where the image quality is ensured, on the leading end of the recording paper P. Furthermore, it is possible to use the conditions of Experiment 4 as long as the degree of smear is within an acceptable range. In other words, the conditions of Experiment 1 to Experiment 4 are usable, but not those of Experiment 5.

### <Others>

The present invention is not limited to the exemplary embodiment described above.

For example, although the voltage is raised from the reverse voltage GV to the transfer voltage TV in the exemplary embodiment, the present invention is not limited thereto.

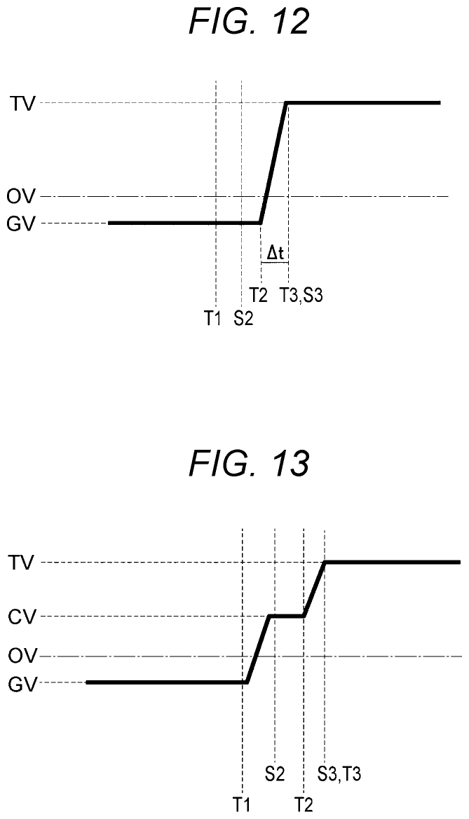

As illustrated in FIG. 13, an intermediate voltage CV may be applied from the reverse voltage GV, and the transfer voltage TV may be applied from the intermediate voltage CV. The intermediate voltage CV has the same polarity as the transfer voltage TV, and is between the transfer voltage TV and the reverse voltage GV.

Note that, in this approach, because the voltage is raised from the intermediate voltage CV to the transfer voltage TV, the time Δt (see FIG. 12) is shortened as compared with that when the voltage is raised from 0V to the transfer voltage TV. Therefore, the timing T2 at which the transfer voltage TV reaches the reference voltage can be advanced. Hence, it is possible to prevent the voltage from reaching the reference voltage behind the inclination rear end 263B of the inclined surface 263A, and thus from a transfer defect from occurring. In addition, because the time Δt is shorter, variation in the timing T2 due to the variation in the time Δt is reduced, that is, the precision of the timing T2 is improved.

Furthermore, for example, in the exemplary embodiment described above, the timing T1 is set by the transfer signal TS that is a detection signal obtained when the photosensor detects the marker provided on the transfer cylinder 36, but the present invention is not limited thereto. For example, the timing T1 may be set based on the reference signal KS used for various kinds of timing adjustment of the entire image forming apparatus 10.

Furthermore, for example, in the exemplary embodiment described above, although the timing T3 is set by adjusting the timing T2 in advance, but setting of the timing T3 it is not limited thereto. The timing T3 may be set by adjusting the time Δt (see FIG. 12) in advance. For example, the timing T3 may be set by adjusting the voltage level of the reverse voltage GV or the intermediate voltage CV in advance, and changing the time Δt.

Furthermore, for example, in the exemplary embodiment described above, the timing T2 is set after the inclination tip end 263C of the inclined surface 263A of the jacket member 260 arrives at the secondary transfer position NT, but the present invention is not limited thereto. The timing T2 may be set to when the inclination tip end 263C arrives at the secondary transfer position NT.

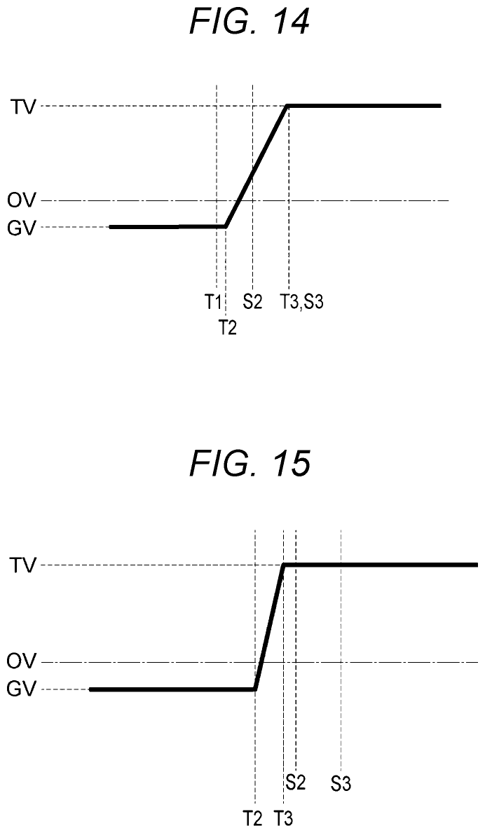

Furthermore, as illustrated in FIG. 14, the timing T2 may be set to a timing before the inclination tip end 263C of the inclined surface 263A of the jacket member 260 arrives at the secondary transfer position NT, that is, before S2, or the timing T3 may be set to a timing after the inclination rear end 263A of the inclined surface 263B arrives at the secondary transfer position NT, that is, after S2.

Furthermore, the cylinder main body 252 may be formed in a substantially columnar shape instead of a substantially hollow cylinder shape. In short, the cylinder main body 252 may have any shape as long as the shape has a substantially circular cross section. The “substantially circular shape” is either a perfect circle or a circular shape close to a perfect circle. The “substantially circular shape” includes a perfect circle. In the present exemplary embodiment, it is a shape in which a recess or the like is formed in a member having a circular cross section.

Furthermore, for example, although the image forming apparatus according to the present exemplary embodiment described above is configured such a manner that the toner images on the transfer belt 31 are transferred onto the recording paper P, the exemplary embodiment not limited thereto. For example, the image forming apparatus may have a configuration in which a toner image on a transfer roller is transferred to the recording paper P.

Furthermore, in the exemplary embodiment described above, a toner image formed by a dry electrophotographic method is used, as an example of the developer image, but the present invention is not limited thereto. For example, the toner image may be a toner image formed by wet electrophotography.

Furthermore, for example, a recording medium other than the recording paper P may be used. The recording medium may be a sheet material such as an OHP sheet, on which a developer image such as a toner image can be transferred and fixed.

Note that the configuration of the image forming apparatus is not limited to the configuration according to the exemplary embodiment described above, and various configurations are possible. Furthermore, the present invention can be carried out in various modes without departing from the gist of the present invention.

### <Supplementary Note>

(((1)))

A transfer device comprising:
a transfer cylinder that is rotated, and that includes a cylinder main body having an outer circumferential surface provided with a recess for housing a holding member holding a leading end of a recording medium to convey the recording medium, and a sheet member that is wound around the outer circumferential surface, both ends of which are attached to circumferential ends of the recess, respectively, and that has an inclined surface on a downstream end in a conveying direction of the recording medium; and
a transfer member to which a transfer voltage is applied and that transfers a developer image to the recording medium held and conveyed by the holding member, at a transfer position,
wherein application of the transfer voltage to the transfer member is started after a tip end of the inclined surface arrives at the transfer position.
   (((2)))

The transfer device according to (((1))), wherein
the transfer voltage applied to the transfer member reaches a reference voltage after a rear end of the inclined surface arrives at the transfer position.
   (((3)))

The transfer device according to (((2))), wherein
the transfer voltage applied to the transfer member reaches the reference voltage when the rear end of the inclined surface arrives at the transfer position.
   (((4)))

The transfer device according to any one of (((1))) to (((4))), wherein
a timing at which application of the transfer voltage is started is adjusted in advance so that the transfer voltage applied to the transfer member reaches a reference voltage after a rear end of the inclined surface arrives at the transfer position.
   (((5)))

The transfer device according to (((4))), wherein
the timing at which application of the transfer voltage is started is adjusted in advance so that the transfer voltage applied to the transfer member reaches the reference voltage when the rear end of the inclined surface arrives at the transfer position.
   (((6)))

The transfer device according to any one of (((5))), wherein
a timing at which application of the transfer voltage to the transfer member is started is set with reference to a detection signal detected when a detection mark provided on the transfer cylinder or a member rotating integrally with the transfer cylinder arrives at a detection position.
   (((7)))

The transfer device according to any one of (((1))) to ((6))), wherein
a reverse voltage having a polarity opposite to a polarity of the transfer voltage is applied to the transfer member before the tip of the inclined surface arrives at the transfer position, and the transfer voltage is applied from the reverse voltage.
   (((8)))

The transfer device according to (((7))), wherein
a value of the reverse voltage is adjusted in advance so that the transfer voltage applied to the transfer member reaches a reference voltage after a rear end of the inclined surface arrives at the transfer position.
   (((9)))

The transfer device according to (((8))), wherein
the value of the reverse voltage is adjusted in advance so that the transfer voltage applied to the transfer member reaches the reference voltage when the rear end of the inclined surface arrives at the transfer position.
   (((10)))

The transfer device according to any one of (((1))) to (((6))), wherein,
before the tip of the inclined surface arrives at the transfer position, a standby voltage having an absolute value smaller than an absolute value of a reference voltage of the transfer voltage is applied to the transfer member, and the transfer voltage is applied from the standby voltage.
   (((11)))

The transfer device according to (((10))), wherein
a value of the standby voltage is adjusted in advance so that the transfer voltage applied to the transfer member reaches the reference voltage after a rear end of the inclined surface arrives at the transfer position.
   (((12)))

The transfer device according to (((11))), wherein
the value of the standby voltage is adjusted in advance so that the transfer voltage applied to the transfer member reaches the reference voltage when a rear end of the inclined surface arrives at the transfer position.
   (((13)))

A transfer device comprising:
a transfer cylinder that is rotated, and that includes a cylinder main body having an outer circumferential surface provided with a recess for housing a holding member holding a leading end of a recording medium to convey the recording medium, and a sheet member that is wound around the outer circumferential surface, both ends of which are attached to circumferential ends of the recess, respectively, and that has an inclined surface on an upstream end in a conveying direction of the recording medium; and
a transfer member to which a transfer voltage is applied and that transfers a developer image to the recording medium held and conveyed by the holding member, at a transfer position,
wherein the transfer voltage applied to the transfer member reaches a reference voltage after a tip of the inclined surface arrives at the transfer position.
   (((14)))

The transfer device according to (((13))), wherein
the transfer voltage applied to the transfer member reaches the reference voltage after a rear end of the inclined surface arrives at the transfer position.
   (((15)))

The transfer device according to (((14))), wherein
the transfer voltage applied to the transfer member reaches the reference voltage when the rear end of the inclined surface arrives at the transfer position.
   (((16)))

An image forming apparatus comprising:
an image forming unit that forms a developer image; and
the transfer device according to any one of (((1))) to (((15))) that transfers the developer image formed by the image forming unit onto a recording medium.

What is claimed is:

1. A transfer device comprising:
a transfer cylinder that is rotated, and that includes a cylinder main body having an outer circumferential surface provided with a recess for housing a holding member holding a leading end of a recording medium to convey the recording medium, and a sheet member that is wound around the outer circumferential surface, both ends of which are attached to circumferential ends of the recess, respectively, and that has an inclined surface on a downstream end in a conveying direction of the recording medium; and
a transfer member to which a transfer voltage is applied and that transfers a developer image to the recording medium held and conveyed by the holding member, at a transfer position,
wherein application of the transfer voltage to the transfer member is started after a tip end of the inclined surface arrives at the transfer position.

2. The transfer device according to claim 1, wherein
the transfer voltage applied to the transfer member reaches a reference voltage after a rear end of the inclined surface arrives at the transfer position.

3. The transfer device according to claim 2, wherein
the transfer voltage applied to the transfer member reaches the reference voltage when the rear end of the inclined surface arrives at the transfer position.

4. The transfer device according to claim 1, wherein
a timing at which application of the transfer voltage is started is adjusted in advance so that the transfer voltage applied to the transfer member reaches a reference voltage after a rear end of the inclined surface arrives at the transfer position.

5. The transfer device according to claim 4, wherein
the timing at which application of the transfer voltage is started is adjusted in advance so that the transfer voltage applied to the transfer member reaches the reference voltage when the rear end of the inclined surface arrives at the transfer position.

6. The transfer device according to claim 1, wherein
a timing at which application of the transfer voltage to the transfer member is started is set with reference to a detection signal detected when a detection mark provided on the transfer cylinder or a member rotating integrally with the transfer cylinder arrives at a detection position.

7. The transfer device according to claim 1, wherein
a reverse voltage having a polarity opposite to a polarity of the transfer voltage is applied to the transfer member before the tip of the inclined surface arrives at the transfer position, and the transfer voltage is applied from the reverse voltage.

8. The transfer device according to claim 7, wherein
a value of the reverse voltage is adjusted in advance so that the transfer voltage applied to the transfer member reaches a reference voltage after a rear end of the inclined surface arrives at the transfer position.

9. The transfer device according to claim 8, wherein
the value of the reverse voltage is adjusted in advance so that the transfer voltage applied to the transfer member reaches the reference voltage when the rear end of the inclined surface arrives at the transfer position.

10. The transfer device according to claim 1, wherein
before the tip of the inclined surface arrives at the transfer position, a standby voltage having an absolute value smaller than an absolute value of a reference voltage of the transfer voltage is applied to the transfer member, and the transfer voltage is applied from the standby voltage.

11. The transfer device according to claim 10, wherein
a value of the standby voltage is adjusted in advance so that the transfer voltage applied to the transfer member reaches the reference voltage after a rear end of the inclined surface arrives at the transfer position.

12. The transfer device according to claim 11, wherein
the value of the standby voltage is adjusted in advance so that the transfer voltage applied to the transfer member reaches the reference voltage when a rear end of the inclined surface arrives at the transfer position.

13. A transfer device comprising:
a transfer cylinder that is rotated, and that includes a cylinder main body having an outer circumferential surface provided with a recess for housing a holding member holding a leading end of a recording medium to convey the recording medium, and a sheet member that is wound around the outer circumferential surface, both ends of which are attached to circumferential ends of the recess, respectively, and that has an inclined surface on an upstream end in a conveying direction of the recording medium; and
a transfer member to which a transfer voltage is applied and that transfers a developer image to the recording medium held and conveyed by the holding member, at a transfer position,
wherein the transfer voltage applied to the transfer member reaches a reference voltage after a tip of the inclined surface arrives at the transfer position.

14. The transfer device according to claim 13, wherein
the transfer voltage applied to the transfer member reaches the reference voltage after a rear end of the inclined surface arrives at the transfer position.

15. The transfer device according to claim 14, wherein
the transfer voltage applied to the transfer member reaches the reference voltage when the rear end of the inclined surface arrives at the transfer position.

16. An image forming apparatus comprising:
an image forming unit that forms a developer image; and
the transfer device according to claim 1 that transfers the developer image formed by the image forming unit onto a recording medium.

17. An image forming apparatus comprising:
an image forming unit that forms a developer image; and
the transfer device according to claim 2 that transfers the developer image formed by the image forming unit onto a recording medium.

18. An image forming apparatus comprising:
an image forming unit that forms a developer image; and
the transfer device according to claim 3 that transfers the developer image formed by the image forming unit onto a recording medium.

19. An image forming apparatus comprising:
an image forming unit that forms a developer image; and
the transfer device according to claim 4 that transfers the developer image formed by the image forming unit onto a recording medium.

20. An image forming apparatus comprising:
an image forming unit that forms a developer image; and
the transfer device according to claim 5 that transfers the developer image formed by the image forming unit onto a recording medium.
